(19) United States
(12) Patent Application Publication
(10) Pub. No.: US 2026/0305537 A1
(43) Pub. Date: Oct. 8, 2026

(54) OVER-THE-DOOR WREATH HOOK THAT PREVENTS A DECORATIVE ITEM FROM BEING STOLEN OR UNSECURED

(71) Applicant: Maria J. Dalmolin, Manvel, TX (US)

(72) Inventor: Maria J. Dalmolin, Manvel, TX (US)

(21) Appl. No.: 19/188,660

(22) Filed: Apr. 24, 2025

Related U.S. Application Data
(60) Provisional application No. 63/784,328, filed on Apr. 7, 2025.

(51) Int. Cl. A01G 5/04; F16M 13/02

(52) U.S. Cl. CPC A01G 5/04; F16M 13/022

(57) ABSTRACT

An apparatus and method are used to secure a decorative item to a door. The apparatus includes an over-the-door hook having an elongate unitary body including a first end, second end and first and second square bends between the first and second ends. The unitary body includes a retaining arm extending from the first end to the first square bend, a hanging arm extending from the second end to the second square bend, and a supporting segment extending between the first and second square bends and connecting to both the retaining arm and the hanging arm. The apparatus further includes a slot extending through the unitary body from a slot opening in the first end to a slot termination within the hanging arm. The hanging arm is longer than the retaining arm and the slot termination within the hanging arm forms a support for hanging the decorative item.

### CROSS-REFERENCE TO RELATED APPLICATIONS

The present application claims the benefit of U.S. Provisional Application No. 63/784,328, filed on Apr. 7, 2025.

### BACKGROUND

The present disclosure relates to methods and apparatus for displaying a decorative item on a door, such displaying a wreath on the front door of a home.

### Background of the Related Art

Hanging a wreath on the front door is a long-standing tradition that symbolizes warmth, welcome, and the changing of the seasons. Rooted in ancient customs, wreaths were originally made of evergreen branches to represent eternal life and the cyclical nature of the year. Today, this practice is especially popular during holidays like Christmas, when wreaths are often adorned with red berries, pinecones, and ribbons to convey festive cheer. However, wreaths are also used year-round to celebrate spring blooms, fall harvests, or simply to add a touch of charm to the home's exterior. Placing a wreath on the front door has become a universal gesture of hospitality, signaling to guests that they are warmly invited in.

A wreath may be displayed in front of a door using a wreath hook. A wreath hook designed to hang over the top of a door features a flat, elongated S-shaped form with a first hook at an upper end and a second hook at a lower end. The first hook opens downward and curves over the top edge of the door so that the wreath hook is supported by the top edge of the door. The second hook opens upward in front of the door so that the wreath can be hung on the second hook. The first hook is thin enough to allow the door to close properly without interference from the first hook, while being strong enough to support the weight of the wreath from the second hook. The front-facing second hook typically includes a small upward extending lip to prevent the wreath from sliding off the second hook as the door is opened and closed. Such a wreath hook creates a hanging point on the door without the need for nails or adhesives, preserving the door's surface and allowing for quick seasonal decoration changes.

While wreaths add a decorative and welcoming touch to a front door, they can also be vulnerable to damage or loss due to environmental factors or theft. Strong winds, especially during stormy weather, can easily dislodge a wreath from the wreath hook, leading to the wreath being blown away or damaged. Additionally, because wreaths are often handmade, seasonal, or even expensive, they can attract the attention of thieves, particularly during the holiday season when decorative items are more prevalent.

### BRIEF SUMMARY

Some embodiments provide an apparatus for securing a decorative item to a door. The apparatus comprises an over-the-door hook having an elongate unitary body including a first end, a second end and first and second square bends between the first and second ends. The unitary body includes a retaining arm extending from the first end to the first square bend, a hanging arm extending from the second end to the second square bend, and a supporting segment extending between the first square bend and the second square bend and connecting to both the retaining arm and the hanging arm. The apparatus further comprises a slot extending through the unitary body from a slot opening in the first end to a slot termination within the hanging arm. The hanging arm is longer than the retaining arm and the slot termination within the hanging arm forms a support for hanging the decorative item.

Some embodiments provide a method of using the apparatus (a décor hanger). The method comprises receiving a component of the decorative item into the slot and moving the component from the slot opening to the slot termination and positioning the over-the door hook in an installed position over a top of a door with the component of the decorative item received in a part of the slot within the hanging arm. In the installed position, the retaining arm is positioned along a first side of the door, the hanging arm is positioned along a second side of the door opposite of the first side of the door, and the supporting segment lies on top of the door. The method further comprises closing the door with the over-the-door hook still in the installed position, wherein the supporting segment extends through a gap between the top of the closed door and a door frame around the door and the retaining arm prevents the supporting segment from being removed from the gap with the door closed. The decorative item hangs from the hanging arm with the component supported by the slot termination and a decorative face of the decorative item directed away from the second side of the door.

### BRIEF DESCRIPTION OF THE SEVERAL VIEWS OF THE DRAWINGS

FIG. 1 is a diagram of a decoration hanger securing a wire wreath frame in front of a closed door.

FIG. 2 is a perspective view of a decoration hanger according to one embodiment.

FIG. 3 is a perspective view of a wire wreath frame including a plurality of wire rings secured together with a plurality of crossbars.

FIGS. 4A-B are front and back views of a wreath including a wire wreath frame that has been decorated on the front side but is accessible from the back side of the wreath.

FIGS. 5A-B are front and cross-sectional views of the decoration hanger positioned so that a crossbar section between the two outer wire rings of the wire wreath frame is aligned with the open end of a slot formed in the decoration hanger.

FIGS. 6A-C are perspective views of the decoration hanger engaging the wire wreath frame so that the crossbar section between the two outer wire rings of the wire wreath frame is moved further into the slot by relative rotation of the decoration hanger from a first intermediate position (FIG. 6A) to a second intermediate position (FIG. 6B) and then to an operative position (FIG. 6C) for hanging from a door.

FIGS. 7A-B are perspective views of the decoration hanger supporting and displaying a wire frame in the shape of a candy cane and a sign to demonstrate the versatility of the decoration hanger.

### DETAILED DESCRIPTION

Some embodiments provide an apparatus for securing a decorative item to a door. The apparatus comprises an over-the-door hook having an elongate unitary body including a first end, a second end and first and second square bends between the first and second ends. The unitary body includes a retaining arm extending from the first end to the first square bend, a hanging arm extending from the second end to the second square bend, and a supporting segment extending between the first square bend and the second square bend and connecting to both the retaining arm and the hanging arm. The apparatus further comprises a slot extending through the unitary body from a slot opening in the first end to a slot termination within the hanging arm. The hanging arm is longer than the retaining arm and the slot termination within the hanging arm forms a support for hanging the decorative item.

Some embodiments of apparatus are adapted for hanging one or more of a wide variety of decorative items. For example, the decorative item may be a seasonal wreath, swag, sign, banner or flag, each having a wide variety of configurations. However, the decorative item should have a component, such as a structural component or a loop designated for hanging, that can be easily positioned within the slot and moved through the slot from the slot opening to the slot termination. The component of the decorative item should have a structure that will not pull through the slot or the decorative item may be attached to other structure that will not pull through the slot. Accordingly, in order to remove the decorative item from the apparatus, the component that will not pull through the slot must be moved back up the slot and out of the slot through the slot opening. However, the slot opening into the slot is positioned on the other side of the door from the hanging structure with the terminal end of the slot that supports the decorative item. As long as the door remains closed, the apparatus (an over-the-door hook) cannot be removed from the door and the decorative item cannot be removed from the apparatus (the over-the-door hook). It is a simple matter to keep the door closed by locking the door when not in use. Accordingly, a thief or the wind would have to destroy the integrity of the door, the apparatus, or the decorative item in order for the decorative item to be released from a locked door.

In some embodiments, the decorative item may be a wreath, such as a wreath including a wire wreath frame. A typical wire wreath frame includes a plurality of wire rings and a plurality of wire cross bars interconnecting the plurality of rings. The wire crossbars may be welded, crimped or hooked to the wire rings. However, the wire wreath frame is rigid and forms a base of support upon which a wide variety of decorative materials may be arranged and attached in an aesthetically pleasing manner. The wire rings and wire crossbars are typically made from round wire, but the slot in the elongate unitary body is not limited to use with any particular component of the decorative item or any particular material or component profile or shape. For example, the slot may secure a component having a round, square or irregular profile, a component made with metal, plastic, twine, cable or string, etc. Furthermore, a metal wire may or may not have a coating, such as a powder coating.

In some embodiments, the apparatus may support a wreath, where the wreath may have a wide range of shapes including a donut (round) shape, star shape, candy cane shape, etc. A common and traditional wreath is donut shaped and may be described as having various numbers of wire rings, various number of cross bars, various wire gauges, various inner and outer diameters and various depths. When a wire wreath frame is not flat, it typically takes on a shallow, three-dimensional dome or bowl-like shape, often referred to as a “rounded” or “raised” wreath frame. In this form, the frame still maintains its circular footprint, but the concentric rings are arranged at different heights, creating a gentle curve or arch from the outer edge toward the center. This three-dimensional structure provides depth and volume, allowing decorative materials to be layered more naturally and giving the finished wreath a fuller, more dynamic appearance. The raised shape also helps the wreath stand out when hung on a door, offering visual interest from various angles and contributing to a more sculptural, elegant presentation.

In some embodiments, the terminal end of the slot may be rounded to provide better support for a rounded wire or other component of the decorative item to be supported by the terminal end of the slot. Furthermore, a rounded terminal end may be less likely to cut or abrade the component that is positioned in the slot.

In some embodiments, the retaining arm, the hanging arm and the support segment are each planar. Accordingly, the retaining arm may extend across the inside surface of the door, the support segment may extend across the top surface of the door, and the hanging arm may extend across the front surface of the door. A close fit will prevent or limit repeated rattling of the apparatus against the door under the forces of wind or opening and closing of the door, but some slack is generally acceptable. Since the front and back surfaces of most doors are parallel, the retaining arm is preferably parallel to the hanging arm. However, in embodiments of the apparatus in which the hanging arm and/or retaining arm are not planar, then the apparatus should have at least a couple of contact points on each side of the door to prevent rattling.

In some embodiments, the apparatus may be characterized in that positioning the over-the-door hook in an installed position over the top of a door and closing the door blocks the decorative item supported in the slot from accessing the slot opening that is on the opposite side of the door. Typically, the decorative item will be displayed on the front or exterior side of the door and the slot opening will be positioned on the back or interior side of the door, but the reverse is also perfectly fine. Accordingly, a decorative item hung from the slot termination in the hanging arm cannot be removed from the slot without opening the closed door.

In some embodiments, the slot has a slot width for receiving a crossbar of a wire wreath frame, wherein the crossbar is connected between first and second wire rings that will not pull through the slot. Furthermore, the slot may receive a strong metal wire loop that is attached to the wreath if the metal wire loop is turned perpendicular to the plane of the wreath hook.

Embodiments of the apparatus are preferably made from a material that is unbreakable without using tools. While it is impractical to make a unit of the apparatus (the over-the-door hook) that is completely indestructible, the apparatus should be strong enough to hold up in common wind conditions and to resist a thief attempting to remove the decorative item or break the over-the-door hook using only their hands. Accordingly, the apparatus may be made with a wide variety of materials, such as metal, metal alloy, many plastics, and carbon fiber composites. Non-limiting examples of a suitable plastic include PEEK (Polyether Ether Ketone), PAI (Polyamide-imide), PPS (Polyphenylene Sulfide), Nylon, Polycarbonate (PC), HDPE (High-Density Polyethylene), and Kevlar® (a trademark of DuPont de Nemours, Inc.). The metal may be any iron, steel or aluminum alloy, but a preferred metal is stainless-steel 304-2B.

Some embodiments of the apparatus may be made from a single unitary piece of sheet metal. For example, the over-the-door hook may be formed by bending the sheet metal to form two square bends, such as by bending the sheet around two bend lines oriented parallel to each other and parallel to a plane of the single unitary piece of sheet metal. Furthermore, the single unitary piece of sheet metal preferably has a narrow dimension and a long dimension, wherein the two bend lines are perpendicular to the long dimension (i.e., perpendicular to a longitudinal axis to the long dimension of the sheet). In one option, the sheet metal may be from 0.5 to 2 millimeters thick. In another option, the sheet metal may be a sheet of stainless steel. In one preferred embodiment, the sheet metal is a 16 gauge (0.060 inch thick) sheet of stainless-steel 304-2B. Still further, the two square bends may have a bend radius from ⅛ to ⅜ inch.

In one non-limiting embodiment, the original metal workpiece is a flat or planar rectangle having a width of about 1.5 inches from side to side, a length of about 16 inches from end to end, and a thickness of about 0.060 inches from face to face. The slot is provided along a central longitudinal axis that is centered between the two sides, extends from one end to a terminal point short of the other end, and is cut through from one face to the opposing face of the sheet. Optionally, the slot may be formed or cut in the same or separate operation that forms the width and length of the metal workpiece. The metal workpiece may then be bent as described herein to include two square bends. For example, a 16 inch long workpiece may be bent to form a 3 inch retaining arm, a 2 inch securing segment and an 11 inch hanging arm.

The distance between the two square bends (i.e., the distance between the retaining arm and the hanging arm) should be great enough to receive the upper edge of a door therebetween. However, the thickness of a door to a residential home or commercial building may vary according to the purpose of the door and the construction material used to make the door. Accordingly, the distance between the two square bends may vary. Still, an interior door typically has a thickness of about 1⅜ inch and an exterior door typically has a thickness of about 1¾ inch. However, the distance between the two square bends may be slightly oversized to account for dimensional tolerances, avoidance of interference with coatings, or struggling to place the apparatus over the door. For example, the distance is preferably from about 1⅞ to 2 inches for an exterior door that is 1¾ inches thick. It should be recognized that the distance could be even greater than 2 inches to accommodate a wider range of door thicknesses, yet the distance is preferable not so much greater than the door thickness that the hanging arm and/or the decorative item may sway back and forth or rattle against the door under forces of opening and closing the door, wind or other jostling.

In some embodiments, the slot may be a longitudinal slot that extends along a major portion of the length of the apparatus, wherein the slot opening is at the first end of the over-the-door hook and the slot termination is within the hanging arm near a second end opposite of the first end. The slot may have a uniform width from the slot opening to the slot termination, where the slot width is selected to receive a structural component of the decorative item, such as the crossbar of a wire wreath frame. M ore particularly, the slot must have a sufficient width so that the structural component can enter the slot inlet and pass through the entire length of the slot to the terminal end of the slot. Optionally, the slot may be wide enough to accommodate structural components having a range of widths, such as 2 or 3 different wire gauges. However, the slot width should not be so large that the strength of the hanger is jeopardized or that the component received in the slot can wobble excessively in the wind or when the door is opened and closed. For example, the slot may have a slot width of about 2.5 millimeters (mm) for the purpose of receiving a wire wreath frame cross bar that has a width or diameter from 1.8 to 2.5 mm. However, the slot width may vary according to the size or range of sizes of the intended component of the decorative item that is to be received within the slot. In other examples, the width of the elongate unitary body may be from 1 to 3 inches and the width of the slot may be from 1/16^{th} to ½ inch.

In some embodiments, one or more features of the apparatus may be cut with a laser. For example, a laser cutting tool may be used to cut out the workpiece used to form the apparatus and/or to cut the slot in the workpiece. Laser cutting is a preferred operation because it can cut the workpiece and/or the slot to precise dimensions while leaving no jagged edges. Alternatively, the workpiece and/or the slot may be formed by one or more other stamping, cutting and/or welding operations.

In some embodiments, the elongate unitary body may have a first side edge, a second side edge, and a width between the first and second side edges, wherein the elongate unitary body has a constant width from the first end to the second end. In one option, the slot may be centered between the first and second side edges. In another option, one or more of the side edges and/or one or more of the ends may be cut with a decorative pattern.

Some embodiments provide a method of using the apparatus (the over-the-door hook). The method comprises receiving a component of the decorative item into the slot and moving the component from the slot opening to the slot termination and positioning the over-the door hook in an installed position over a top of a door with the component of the decorative item received in a part of the slot within the hanging arm. In the installed position, the retaining arm is positioned along a first side of the door, the hanging arm is positioned along a second side of the door opposite of the first side of the door, and the supporting segment lies on top of the door. The method further comprises closing the door with the over-the-door hook still in the installed position, wherein the supporting segment extends through a gap between the top of the closed door and a door frame around the door and the retaining arm prevents the supporting segment from being removed from the gap with the door closed. The decorative item hangs from the hanging arm with the component supported by the slot termination and a decorative face of the decorative item directed away from the second side of the door. It should be appreciated that the closed door blocks the component of the decorative item from moving out through the slot opening.

In some embodiments of the method, the decorative item is a wreath that includes a wire wreath frame having a crossbar connected between two wire rings, wherein the component received into the slot is the crossbar. Accordingly, the wreath hangs flat against the second side of the door with the crossbar directed through the slot.

In some embodiments of the method, the decorative item includes a rigid loop for hanging the decorative item, wherein the component received into the slot is one side of the rigid loop. Accordingly, the decorative item hangs flat against the second side of the door with the rigid loop directed through the slot.

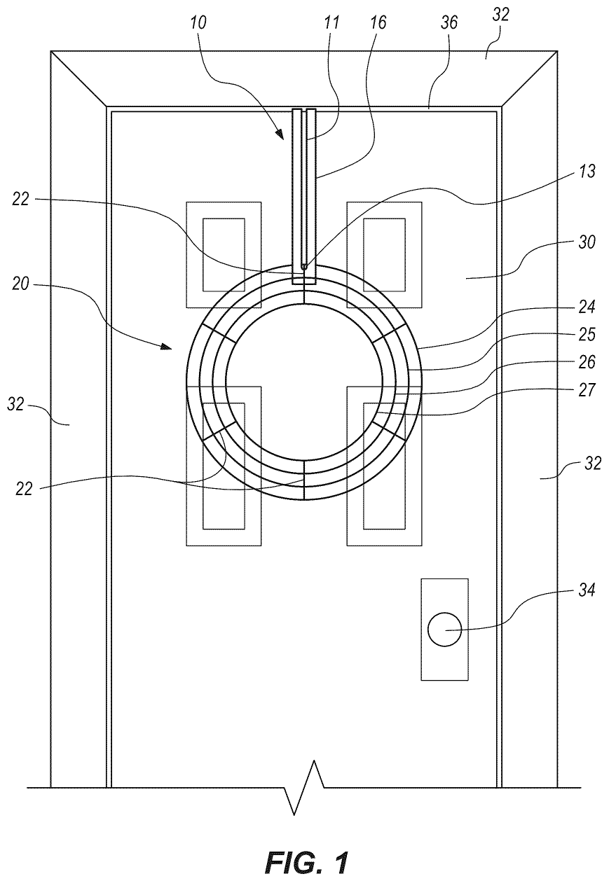

FIG. 1 is a diagram of an over-the-door hook (i.e., a decoration hanger) 10 securing a wire wreath frame 20 in front of a closed door 30. The closed door 30 may be hinged to a door frame 32 that extends around the door and may include a handle 34 for opening and closing the door. The handle typically will include a locking mechanism to prevent unauthorized people from opening the door. A small gap 36 is typically provided between the outer edges of the door 30 and the inner edges of the door frame 32

The over-the-door hook 10 has a securing segment that fits in the gap 36 and a hanging arm 12 that extends downward along the front surface of the door 30. A slot 11 within the over-the-door hook 10 extends along a major portion of the length of the over-the-door hook 10 to a slot termination 13. At the slot termination 13, one of the crossbars 22(6 crossbars are shown) of the wire wreath frame 20 extends through the slot 11 and rests on the slot termination 13 Each of the crossbars 22 is connected to each of the four rings 24, 25, 26, 27 and one of the crossbars 22 extends through the slot 11 from the back of the over-the-door hook 10 to the front of the over-the-door hook 10. Specifically, the selected crossbar 22 extends through the slot 11 with the largest diameter (outermost) ring 24 positioned behind the hanging arm 12 and the second largest diameter ring 25 positioned in front of the hanging arm 12 Accordingly, the ring 24 prevents the selected crossbar 22 from pulling out of the slot 11 in a forward direction (directed away from the door 30) and the ring 25 prevents the selected crossbar 22 from pulling out of the slot 11 in a reverse direction (directed toward the door 30). The only way to remove the wire wreath frame 20 from the over-the-door hook 10 requires opening the door.

While a wire wreath frame 20 is shown without decorations, the wire wreath frame 20 is typically used as a base to form a wreath that is fully decorated to hide most or all of the wire wreath frame 20. The relationship between the wire wreath frame 20 and the fully decorated wreath is shown in reference to FIGS. 4A-B, but the interconnection between the wire wreath frame 20 and the over-the-door hook 10 is shown in FIG. 1

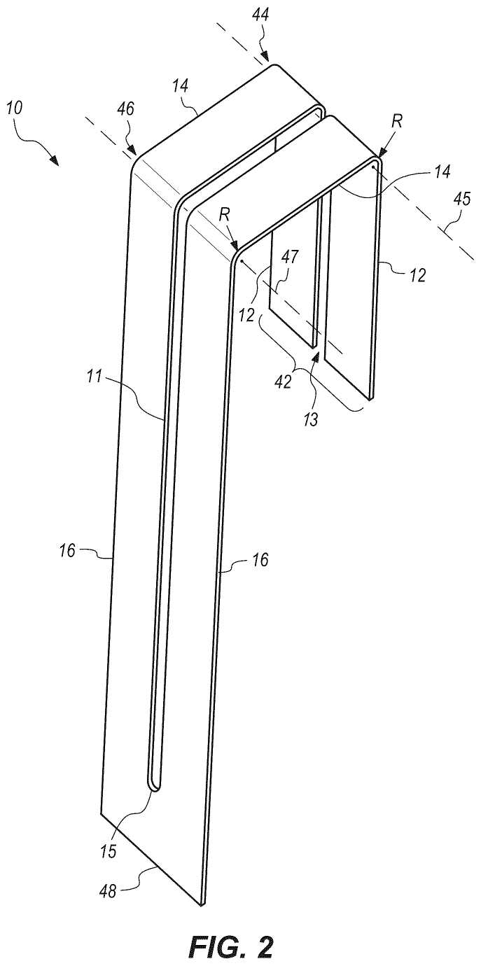

FIG. 2 is a perspective view of the over-the-door hook 10 according to one embodiment. The over-the-door hook 10 has an elongate unitary body including a first end 42 a second end 44 and first and second square bends 44, 46(i.e., 90 degree bends) between the first and second ends 42, 44 The unitary body includes a retaining arm 12 extending from the first end 42 to the first square bend 44, a hanging arm 16 extending from the second end 48 to the second square bend 46, and a supporting segment 14 extending between the first square bend 44 and the second square bend 46 and securing to both the retaining arm 12 and the hanging arm 16 The slot 11 extending through the unitary body from a slot opening 13 in the first end 42 to a slot termination 15 within the hanging arm 16 The hanging arm 16 is longer than the retaining arm 12 and the slot termination 15 within the hanging arm 16 forms a support for hanging the decorative item (as shown in FIG. 1). Furthermore, the first square bend 44 may be described as having a bend radius (R) about a bend line 45 and the second square bend 46 may be described as having a bend radius (R) about a bend line 47. As shown, the slot 11 is centered between the right and left side edges of the over-the-door hook 10.

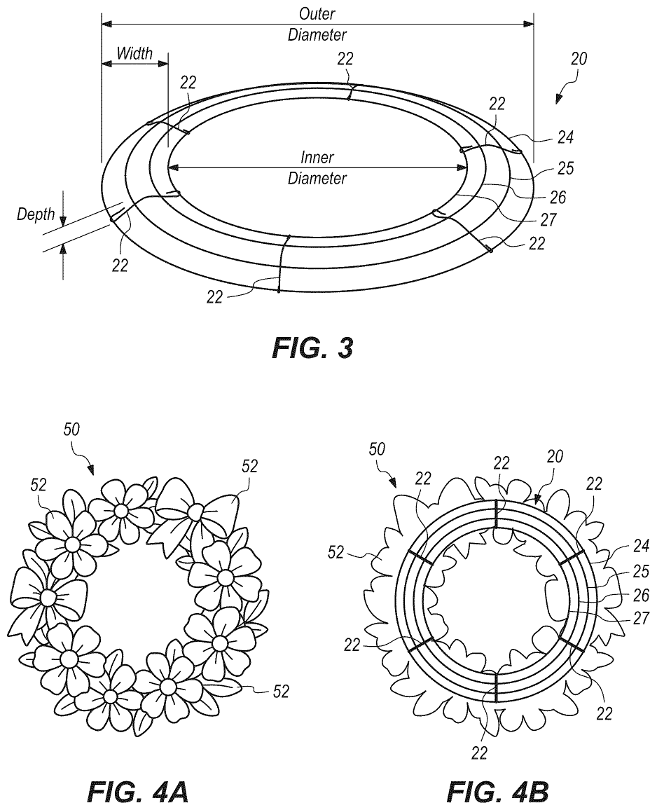

FIG. 3 is a perspective view of the wire wreath frame 20 including the plurality of wire rings 24, 25, 26, 27 secured together with a plurality of crossbars 22 Although the shape and size of decorative items may vary widely, the illustrated a wire wreath frame 20 may be referred to as having a donut shape. The wire wreath frame 20 is shown to have an outer diameter (defined by the largest diameter ring 24), an inner diameter (defined by the smallest diameter ring 27), a width (the difference in the radius of the largest and smallest diameter rings 24, 27) and a depth. The crossbars 22 are typically arched or curved outward to raise the central rings 25, 26 out of the plane of the outer and inner rings 24, 27.

FIGS. 4A-B are front and back views of a wreath 50 including a wire wreath frame 20 that has been adorned with decorations 52 on the front side of the wreath 50 but is accessible from the back side of the wreath 50. As shown, any of the crossbars 22 are accessible from the back side of the wreath 50 for the purpose of hanging the wreath 50 from the over-the-door hook 10 as shown in FIG. 1

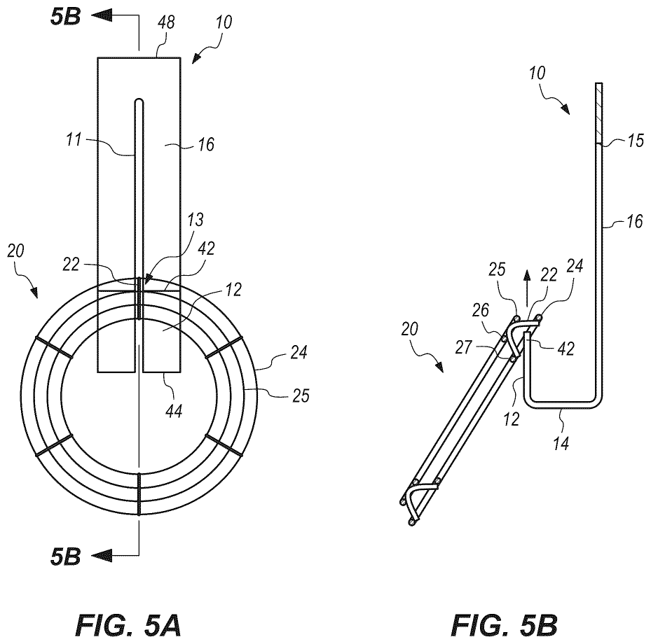

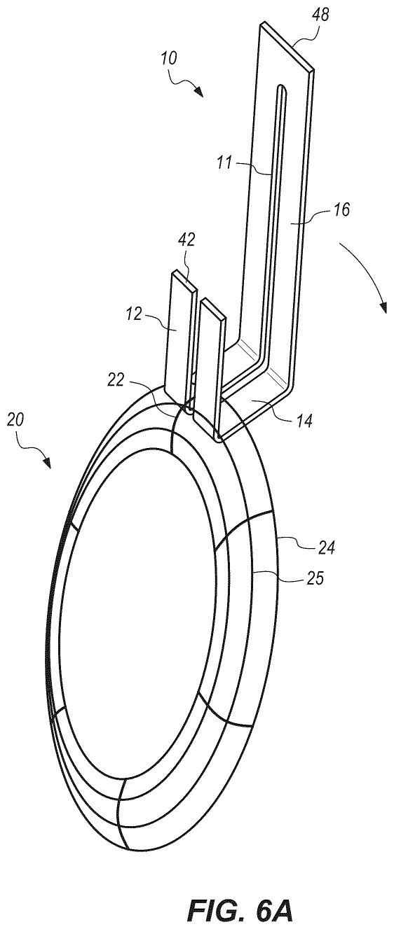

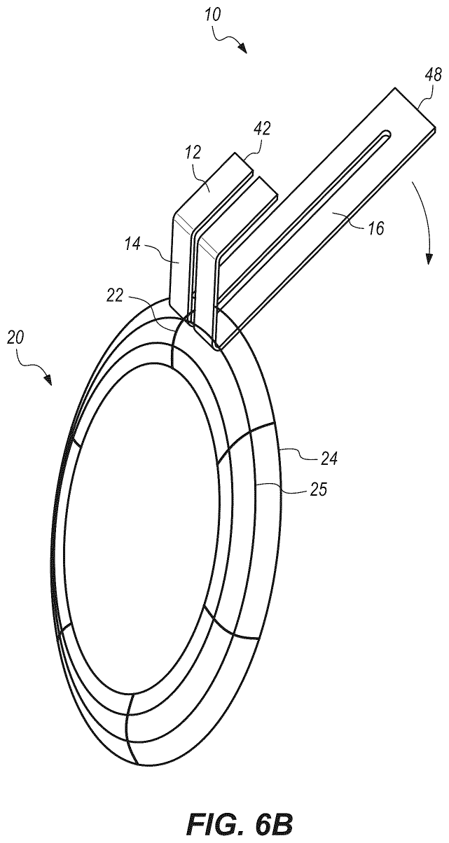

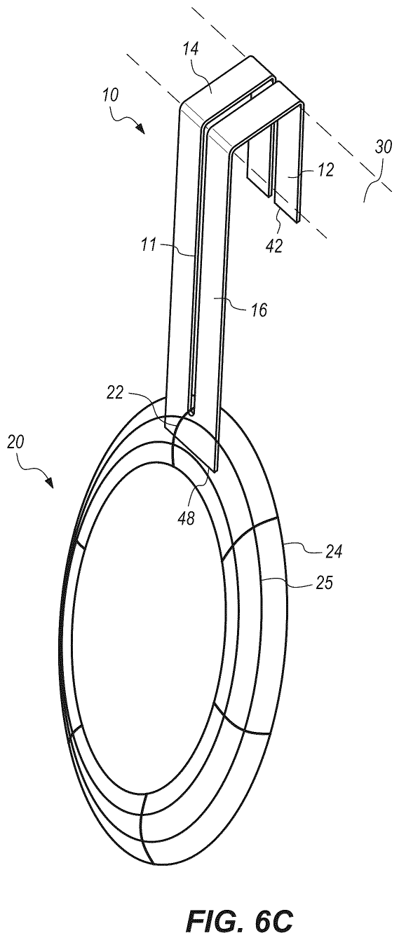

FIGS. 5A-B are front and cross-sectional views of the over-the-door hook 10 positioned so that a crossbar section 22 between the two outer wire rings 24, 25 of the wire wreath frame 20 is aligned with the slot opening 13 of the slot 11 formed in the over-the-door hook 10. In reference to FIG. 5A, the wire wreath frame 20 (of a wreath 50 as shown in FIGS. 4A-B) positioned in a generally upright position as in FIGS. 1 and 4A-4B, and the over-the-door hook 10 is 180 degrees inverted relative to the orientation shown in FIGS. 1 and 2 Accordingly, the retaining arm 12 is in front of the hanging arm 16 and the first end 42 is pointing up between the two outer wire rings 24, 25 and with the slot 11 aligned with the selected crossbar 22 In reference to FIG. 5B, the retaining arm 12 is more clearly shown to be in front of the hanging arm 16 and the first end 42 is pointing up between the two outer wire rings 24, 25 From this position, moving the over-the-door hook 10 upward will cause the crossbar 22 to enter the slot opening 13 of the slot 11 The further movement of the crossbar 22 within the slot 11 is shown in FIGS. 6A-C.

FIGS. 6A-C are perspective views of the over-the-door hook 10 engaging the wire wreath frame 20 so that the section of the crossbar 22 between the two outer wire rings 24, 25 of the wire wreath frame 20 is moved further into the slot 11 by relative rotation (clockwise as shown in FIGS. 6A-6C) of the over-the-door hook 10 from a first intermediate position (FIG. 6A) to a second intermediate position (FIG. 6B) and then to an operative position (FIG. 6C) for hanging from a door. With the wire wreath frame 20 secured in the slot 11 and the over-the-door hook 10 in the operative position, the over-the-door hook 10 may then be placed over the top of a door 30 (the top edge of the door 30 being shown in dashed lines in FIG. 6C.).

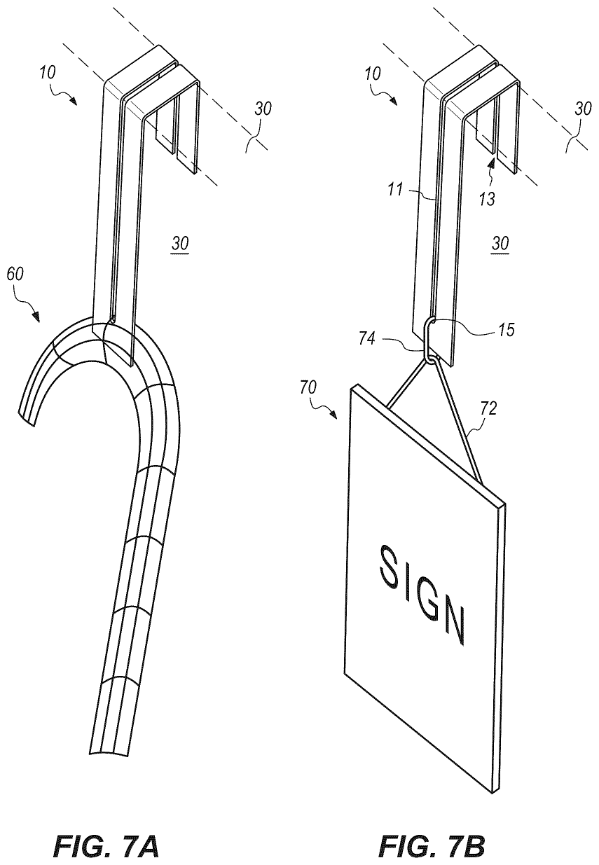

FIGS. 7A-B are perspective views of the over-the-door hook 10 supporting and displaying a wire frame 60 in the shape of a candy cane and a sign 70 to demonstrate the versatility of the decoration hanger. While the wire frame 60 in FIG. 7A has a candy cane shape rather than a donut shape, the wire frame 60 would be attached to the over-the-door hook 10 is the very same manner as described for a donut shaped wreath. In reference to FIG. 7B, the sign 70 includes a wire hanger 72 and a metal ring 74. The opening in the metal ring 74 enables the metal ring 74 to be threaded onto over-the-door hook 10 from the slot opening 13 along the length of the slot 11 to the slot termination 15 prior to hanging the over-the-door hook 10 on the door 30.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but the invention is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

1. An apparatus for securing a decorative item to a door, comprising:
an over-the-door hook having an elongate unitary body including a first end, a second end and first and second square bends between the first and second ends, wherein the unitary body includes a retaining arm extending from the first end to the first square bend, a hanging arm extending from the second end to the second square bend, and a supporting segment extending between the first square bend and the second square bend and connecting to both the retaining and the hanging arm; and
a slot extending through the unitary body from a slot opening in the first end to a slot termination within the hanging arm, wherein the hanging arm is longer than the retaining arm, and wherein the slot termination within the hanging arm forms a support for hanging the decorative item.

2. The apparatus of claim 1, wherein the retaining arm, the hanging arm and the support segment are each planar.

3. The apparatus of claim 1, wherein the retaining arm is parallel to the hanging arm.

4. The apparatus of claim 1, wherein positioning the over-the-door hook in an installed position over a top of a door and closing the door blocks access to the slot opening.

5. The apparatus of claim 4, wherein a decorative item hung from the slot termination in the hanging arm cannot be removed from the slot without opening the closed door.

6. The apparatus of claim 5, wherein the slot has a slot width for receiving a crossbar of a wire wreath frame, and wherein the crossbar connected between first and second wire rings that will not pull through the slot.

7. The apparatus of claim 1, wherein the over-the-door hook is made from a material that is unbreakable without using tools.

8. The apparatus of claim 1, wherein the over-the-door hook is made from a single unitary piece of sheet metal.

9. The apparatus of claim 8, wherein the over-the-door hook is formed by bending the sheet metal to form two square bends.

10. The apparatus of claim 9, wherein the sheet is bent around two bend lines oriented parallel to each other and parallel to a plane of the single unitary piece of sheet metal.

11. The apparatus of claim 10, wherein the sheet metal is between 0.5 to 2 millimeters thick.

12. The apparatus of claim 11, wherein the sheet metal is a sheet of stainless steel.

13. The apparatus of claim 10, wherein the sheet is bent around the two bend lines to form a bend radius of between ⅛ to ⅜ inch.

14. The apparatus of claim 1, wherein the slot has a uniform width from the slot opening to the slot termination.

15. The apparatus of claim 14, wherein the elongate unitary body has a first side edge, a second side edge, and a width between the first and second side edges, wherein the elongate unitary body has a constant width from the first end to the second end, and wherein the slot is centered between the first and second side edges.

16. The apparatus of claim 15, wherein the width of the elongate unitary body is from 1 to 3 inches, and wherein the width of the slot is from 1/16^{th} to ½ inch.

17. A method of using the apparatus of claim 1, comprising:
receiving a component of the decorative item into the slot and moving the component from the slot opening to the slot termination;
positioning the over-the door hook in an installed position over a top of a door with the component of the decorative item received in a part of the slot within the hanging arm, wherein the retaining arm is positioned along a first side of the door, the hanging arm is positioned along a second side of the door opposite of the first side of the door, and the supporting segment lies on top of the door; and
closing the door with the over-the-door hook still in the installed position, wherein the supporting segment extends through a gap between the top of the closed door and a door frame around the door and the retaining arm prevents the supporting segment from being removed from the gap, and wherein the decorative item hangs from the hanging arm with the component supported by the slot termination and a decorative face of the decorative item directed away from the second side of the door.

18. The method of claim 17, wherein the closed door blocks the component of the decorative item from moving out through the slot opening.

19. The method of claim 17, wherein the decorative item is a wreath that includes a wire wreath frame having a crossbar connected between two wire rings, wherein the component received into the slot is the crossbar, and wherein the wreath hangs flat against the second side of the door with the crossbar directed through the slot.

20. The method of claim 17, wherein the decorative item includes a rigid loop for hanging the decorative item, wherein the component received into the slot is one side of the rigid loop, and wherein the decorative item hangs flat against the second side of the door with the rigid loop directed through the slot.
